(19) United States
(12) Patent Application Publication
(10) Pub. No.: US 2013/0052312 A1
(43) Pub. Date: Feb. 28, 2013

(54) METHOD OF MAKING NON-ALCOHOLIC AND ALCOHOLIC TODDY DRINKS

(71) Applicants: Thyvalikakath Mathew Paul, Pittsburgh, PA (US); Thankam Paul Thyvalikakath, Pittsburgh, PA (US)

(72) Inventors: Thyvalikakath Mathew Paul, Pittsburgh, PA (US); Thankam Paul Thyvalikakath, Pittsburgh, PA (US)

(21) Appl. No.: 13/560,316

(22) Filed: Jul. 27, 2012

Related U.S. Application Data
(60) Provisional application No. 61/526,285, filed on Aug. 23, 2011.

(51) Int. Cl. A23L 2/50; C12H 1/16; A23L 2/74; A23L 2/38

(52) U.S. Cl. 426/234; 426/240; 426/590; 426/592; 426/598; 426/490

(57) ABSTRACT

Method steps to manufacture non-alcoholic and alcoholic toddy drinks by use of only irradiation (gamma irradiation) or only filtering. The present invention will enable the shelf life of the toddy drink to be extended for several months and possibly years without change in the nature and taste of the toddy drink. One embodiment of the present invention can be used to preserve the toddy drink before fermentation starts to produce a sweet organic soft (non-alcoholic) drink. Another embodiment can be used to control fermentation of the toddy drink to produce a sweet organic hard (alcoholic) drink. Irradiation or filtration keeps the food material almost intact and at the same time destroys the microbes and parasites. Irradiation can be done after packing or bottling in small measures or in bulk quantities. Filtration is performed in bulk quantities.

### CROSS-REFERENCE TO RELATED APPLICATIONS

This application is a Non-provisional Application of U.S. Provisional Application No. 61/526,285, titled METHOD OF MAKING NON-ALCOHOLIC AND ALCOHOLIC TODDY DRINKS, filed on Aug. 23, 2011, herein incorporated by reference.

### FIELD OF THE INVENTION

The present invention is related generally to the method steps of manufacturing non-alcoholic and alcoholic toddy drinks, and in particular to a process using irradiation or filtration to inhibit the fermentation process.

### BACKGROUND OF THE INVENTION

Toddy drinks are made by de-juicing or slicing of the flower stalk of coconut or palm trees or from coconut water. The Palm family includes Palyra Date palms, Silver date palms, poneix sylvestris, Jaggery palms, caryota arnes, oil palms, Elasesisguineense, kithal palms, nipa palms, South African lala palms, and hyphaene palms. The Palm family belongs to Aracaceae and genus is Cocos Nocifera. Palm trees thrive where there is plenty of sunshine and an average rainfall of 150 cms to 250 ems per annum with a temperature above 24 degrees Celsius (75.2 degrees Fahrenheit). Palm trees grow in more than 80 countries between the Tropic of Cancer and the Tropic of Capricorn. There is exists more than 3 billion palms with an average life span of 80 to 100 years.

The Toddy juice starts to ferment within 2-3 hours after de-juicing, and between 24 to 30 hours the toddy drink has an ethyl alcohol content of 4-6% caused by yeast that converts carbohydrate whereby carbon dioxide is removed from pyruvic acid to form acetaldehyde, which is reduced by nicotinamide adenine dinucleotide to form ethyl alcohol. After 30 hours, the Toddy juice becomes acidic and vinegar is produced. Therefore, this requires consumption of the toddy juice within 3 hours for a non-alcoholic toddy drink or within 30 hours for an alcoholic toddy drink.

Currently, there is no method by which the toddy juice can be preserved without denaturing the juice. By refrigeration, the shelf life can be prolonged for a few days. By pasteurization, the toddy juice is denatured and the taste of the toddy drink changes. By the use of chemicals to kill yeast in the toddy juice, the taste of the toddy drink also changes.

### SUMMARY OF THE INVENTION

The present invention are method steps to manufacture non-alcoholic and alcoholic toddy drinks by use of only irradiation or only filtration. One embodiment of the present invention includes a process using gamma irradiation to inhibit the fermentation process. Another embodiment of the present invention includes a process using filtration to inhibit the fermentation process. The present invention will enable the shelf life of the toddy drink to be extended for several months and possibly years without change in the nature and taste of the toddy drink. One embodiment of the present invention can be used to preserve the toddy drink before fermentation starts to produce a sweet organic soft (non-alcoholic) drink. Another embodiment of the present invention can be used to control fermentation of the toddy drink to produce a sweet organic hard (alcoholic) drink.

Irradiation and/or filtration keeps the food material almost intact and at the same time destroys the microbes and parasites. Often the material properly packed can maintain the freshness for years. Irradiation can be done after packing or bottling in small measures or in bulk quantities. Whereas, filtration is performed in bulk quantities. Irradiation and/or filtration of the toddy juice has minimal effects on the vitamins and other nutrients in the toddy drink and causes very little difference in the taste and smell.

Coconut water is the fluid contained inside the nut having some sugar as well as minerals. If it is collected in a sterile receptacle without any human contact and without any contamination, then it can be considered sterile, equivalent to intravenous fluids administered to patients. In fact during cholera epidemics during World War II, coconut water was used as intravenous fluids. Hence coconut water can be treated with gamma radiation and alternatively by filtration to remove microbes, for the purpose of preservation.

### BRIEF DESCRIPTION OF THE DRAWINGS

For the present invention to be easily understood and readily practiced, the invention will now be described, for the purposes of illustration and not limitation, in conjunction with the following figures, wherein:

FIG. 1 is a flow diagram of the present invention process steps to manufacture toddy drinks using irradiation; and

FIG. 2 is a flow diagram of the present invention process steps to manufacture toddy drinks using filtration.

### DETAILED DESCRIPTION OF THE INVENTION

Any irradiation or filtration process is acceptable for use in the present invention. The present invention will be illustrated herein using gamma irradiation as one type of irradiation process and it is not intended to limit the present invention to only gamma irradiation.

Irradiation Process

Gamma irradiation uses either Cobalt 60 or Cesium 137 isotopes. The dosage necessary to destroy yeast is about 4 to 9 kGy (Gray=1 joule of energy/Kg of food, 1 Gy=100 rads, 1 kGy=1000 Gy). Bacteria and other microbes can be destroyed using about 1 to 2.3 kGy of gamma irradiation. The percentage of alcohol will vary according to the time of irradiation after the toddy juice is collected. There will be no alcohol of any discernable quantity if the toddy juice is irradiated within 3 hours of collection from the tree. Between 3 hours and 24 hours after collection, the alcohol content of the toddy juice will range from slightly more than zero to about 4%. The alcohol content reaches a maximum of 4 to 6% by about 24 to about 30 hours after collection from the trees. There is no need to stir the toddy juice while it is being irradiated. Commercial irradiation equipment are available from manufacturers such as, but not limited to, General Electric, Westinghouse, Siemens, Toshiba, Hitachi, and Thomson of France.

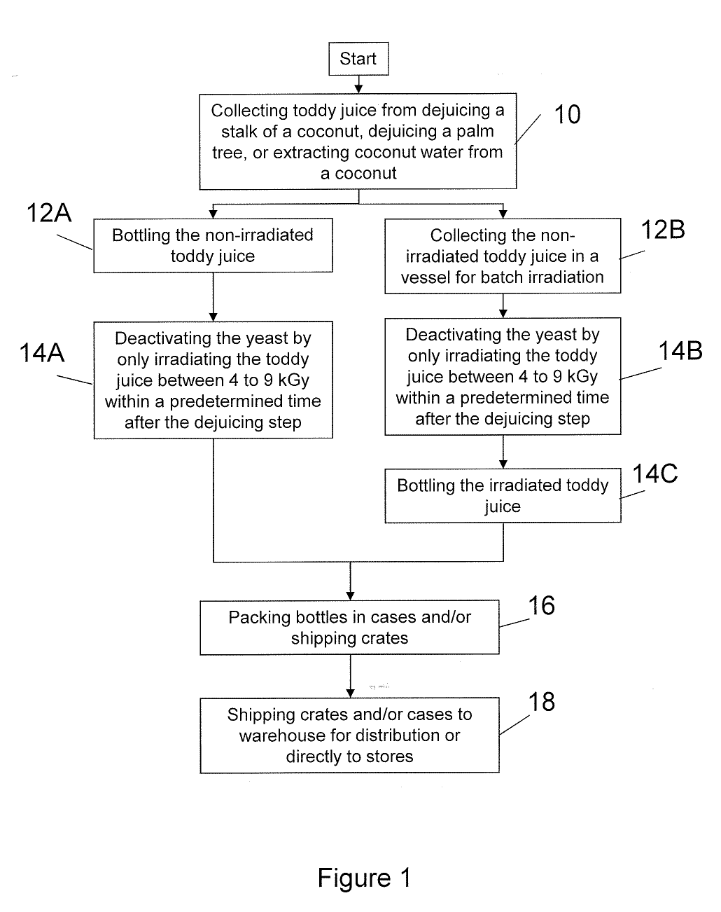

Now turning to FIG. 1 that illustrates a flow diagram of the present invention irradiation process steps to manufacture non-alcoholic and alcoholic toddy drinks.

One embodiment of the present invention for preparing a non-alcoholic Toddy drink includes: dejuicing a stalk of a coconut, dejuicing a stalk of a palm tree, or extracting coconut water from a coconut to collect coconut water (Block 10), bottling the non-irradiated toddy juice (Block 12A), deactivating yeast in the toddy juice in the bottles by only irradiating the toddy juice between 4 to 9 kGy within a predetermined time (within about 3 hours) after the dejuicing step to produce the non-alcoholic Toddy drink (Block 14A), packing the irradiate bottles in cases and/or shipping crates (Block 16), and shipping crates and/or shipping crates to warehouses for distribution or directly to stores (Block 18). As discussed above, any irradiation process is acceptable including gamma irradiation. This process eliminates the need for refrigeration, pasteurization, or chemical additives to deactivate the yeast necessary for fermentation. Microorganisms and fungi are destroyed by irradiation, thus producing a safe and sterile drink.

Another embodiment of the present invention for preparing a non-alcoholic Toddy drink includes: dejuicing a stalk of a coconut, dejuicing a stalk of a palm tree, or extracting coconut water from a coconut to collect coconut water (Block 10), collecting the non-irradiated toddy juice in a vessel for batch irradiation (Block 12B), deactivating yeast in the toddy juice in the bottles by only irradiating the toddy juice between 4 to 9 kGy within a predetermined time (within about 3 hours) after the dejuicing step to produce the non-alcoholic Toddy drink (Block 14A), bottling the irradiated toddy juice (Block 14C), packing the irradiate bottles in cases and/or shipping crates (Block 16), and shipping crates and/or shipping crates to warehouses for distribution or directly to stores (Block 18). As discussed above, any irradiation process is acceptable including gamma irradiation. This process eliminates the need for refrigeration, pasteurization, or chemical additives to deactivate the yeast necessary for fermentation. Microorganisms and fungi are also destroyed by irradiation, thus producing a safe and sterile drink.

Another embodiment of the present invention for preparing an alcoholic Toddy drink includes: dejuicing a stalk of a coconut, dejuicing a stalk of a palm tree, or extracting coconut water from a coconut to collect coconut water (Block 10), bottling the non-irradiated toddy juice (Block 12A), deactivating yeast in the toddy juice by only irradiating the toddy juice between 4 to 9 kGy between about 24 hours to about 30 hours of the dejuicing step to produce the alcoholic Toddy drink with an alcohol content of 4 to 6% (8 to 12 proof), packing the irradiate bottles in cases and/or shipping crates (Block 16), and shipping crates and/or shipping crates to warehouses for distribution or directly to stores (Block 18). As discussed above, any irradiation process is acceptable including gamma irradiation. This process eliminates the need for refrigeration, pasteurization, or chemical additives to deactivate the yeast necessary for fermentation. Microorganisms and fungi are also destroyed by irradiation, thus producing a safe and sterile drink.

Another embodiment of the present invention for preparing an alcoholic Toddy drink includes: dejuicing a stalk of a coconut, dejuicing a stalk of a palm tree, or extracting coconut water from a coconut to collect coconut water (Block 10), collecting the non-irradiated toddy juice is a vessel for batch irradiation (Block 12B), deactivating yeast in the toddy juice by only irradiating the toddy juice between 4 to 9 kGy between about 24 hours to about 30 hours of the dejuicing step to produce the alcoholic Toddy drink with an alcohol content of 4 to 6% (8 to 12 proof) (Block 14B), bottling the irradiated toddy juice (Block 14C), packing the irradiate bottles in cases and/or shipping crates (Block 16), and shipping crates and/or shipping crates to warehouses for distribution or directly to stores (Block 18). As discussed above, any irradiation process is acceptable including gamma irradiation. This process eliminates the need for refrigeration, pasteurization, or chemical additives to deactivate the yeast necessary for fermentation. Microorganisms and fungi are also destroyed by irradiation, thus producing a safe and sterile drink.

Another embodiment of the present invention includes the step of filtering the toddy juice before the step of irradiating.

Another embodiment of the present invention includes the step of collecting the toddy juice in a vessel for batch irradiation before the step of irradiating the toddy juice.

Another embodiment of the present invention includes the step of filtering the toddy drink after the step of irradiation.

Filtration Process

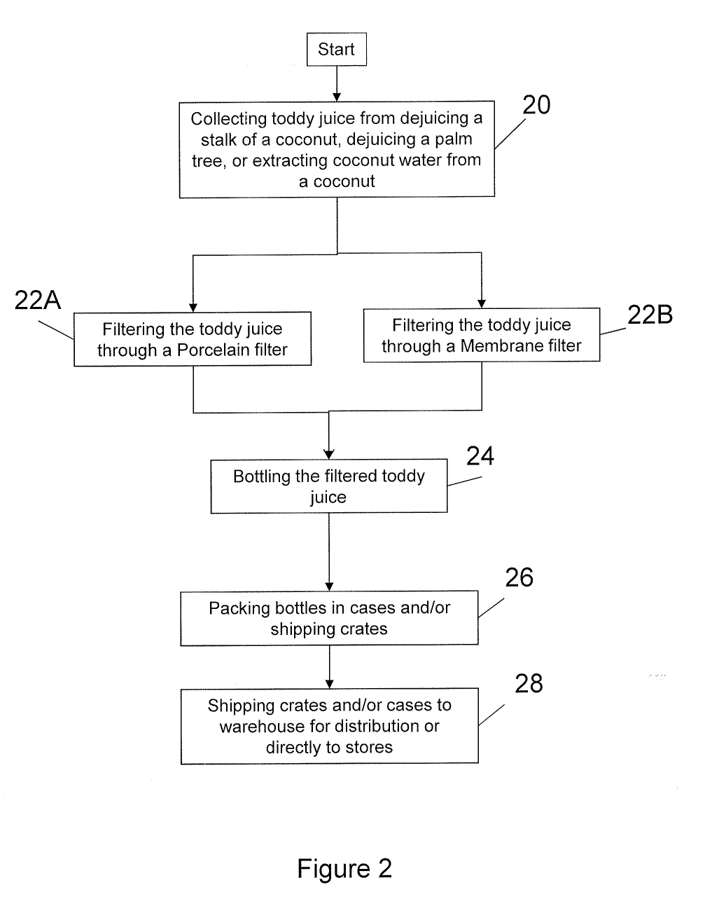

An alternative embodiment of the present invention uses filtration instead of irradiation to inhibit fermentation by the removal of yeast and other microbes as shown in FIG. 2. The collection of the toddy juice is the same as described above for the irradiation process: dejuicing a stalk of a coconut, dejuicing a stalk of a palm tree, or extracting coconut water from a coconut to collect coconut water (Block 20), the toddy juice is filtered through porcelain filters (Block 22A) or membrane filters (Block 22B) (filters discussed in detail below), bottling the filtered toddy drink (Block 24), packing bottles into crates/cases for shipping (Block 26), and shipping crates/cases to warehouses for distribution or directly to stores (Block 28).

Porcelain filters or Membrane Filters can be used for the filtration process. In order to filter the micro-organisms and bacteria, the pores of the porcelain and membrane filters must be 0.5 microns and above. Porcelain filters are numbered 1 to 13, where 1 has the coarsest pores and 13 has finest pores. For filtering yeast the pores size is to be 5 microns or lower. Therefore, a preferable pores size range from about 0.5 microns to 0.75 microns to filter out all harmful organisms and yeast.

Porcelain filters were invented in 1884 and are known as Chamberland Filter/Pastuer Chamberland Filter, and are similar to Berkfield Filters. Porcelain filters can consist of unglazed porcelain tube that contains a ring of enameled porcelain through which inflow pipe is fitted. The core of the porcelain tube can consist of metal pipe with holes through which fluid flows out and is collected. Inflow through the porcelain filter can be pressurized such that filtration occurs under pressure. Any commercially available Porcelain filter is sufficient providing the pore size allows for adequate filtration of all harmful organisms and yeast. Some manufacturers are Synkera Technologies Inc. (2605 Trade Centre Avenue, Suite C, Longmont, Colo. 808503), H2O Distributors (1061 Triad Court, Suite 9, Marietta, Ga. 30062), and American Filtration (P.O. Box 4142, 601 Lily, Corpus Christi, Tex. 78469).

Membrane Filters can be ceramic membrane or polymer membranes. Ceramic membrane is produced with inorganic materials such as aluminum oxides, silicon carbide and zirconium oxide. They are resistant to active media like acids and strong solvents. They are stable chemically, thermally, and mechanically and biologically inert. They have high weight and are costly but ecologically friendly and have long working life span. Any commercially available ceramic filter is sufficiently for separation of microbes and low affinity to the liquid used and must be biocompatible. Some manufacturers are EMD Millipore (290 Concord Road, Billerica, Mass. 01821), Critical Process Filtration Inc. (One Chestnut Street, Nashua, N.H. 03060), and Sterlitech Corporation (22027 70th Avenues, Kent, Wash. 98032-1911).

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method for preparing a non-alcoholic Toddy drink from a toddy juice collected from a stalk of a coconut, a stalk of a palm tree, or coconut water, the method comprising the step of:
deactivating yeast in the toddy juice by only irradiating the toddy juice between 4 to 9 kGy within a predetermined time to produce the non-alcoholic Toddy drink,
wherein no refrigeration, no pasteurization, and no chemical additives are used in the yeast deactivating step.

2. The method according to claim 1, wherein the irradiating step is gamma irradiation.

3. The method according to claim 1, further comprising the step of bottling the toddy juice before the step of irradiating.

4. The method according to claim 1, further comprising the step of collecting the toddy juice in a vessel for batch irradiation before the step of irradiating the toddy juice.

5. The method according to claim 4, further comprising the step of bottling the toddy drink after the step of irradiating.

6. The method according to claim 1, wherein the predetermined time is within 3 hours.

7. The product of the process according to claim 1.

8. A method for preparing an alcoholic Toddy drink from a toddy juice collected from a stalk of a coconut, a stalk of a palm tree, the method comprising the step of:
deactivating yeast in the toddy juice by only irradiating the toddy juice between 4 to 9 kGy between about 3 hours to about 30 hours of the dejuicing step to produce the alcoholic Toddy drink with an alcohol content,
wherein no refrigeration, no pasteurization, and no chemical additives are used in the yeast deactivating step.

9. The method according to claim 8 wherein the irradiating step is gamma irradiation.

10. The method according to claim 8 further comprising the step of bottling the toddy juice before the step of irradiating.

11. The method according to claim 8 further comprising the step of collecting the toddy juice in a vessel for batch irradiation before the step of irradiating the toddy juice.

12. The method according to claim 10 further comprising the step of bottling the toddy drink after the step of irradiating.

13. The product of the process according to claim 8.

14. A method for preparing a non-alcoholic Toddy drink from a toddy juice collected from a stalk of a coconut, a stalk of a palm tree, or coconut water, the method comprising the step of:
deactivating yeast in the toddy juice by only filtering the toddy juice to produce the non-alcoholic Toddy drink,
wherein no refrigeration, no pasteurization, and no chemical additives are used in the yeast deactivating step.

15. The method according to claim 14, wherein a Porcelain filter is used in the filtering step.

16. The method according to claim 14, wherein a membrane filter is used in the filtering step.

17. The method according to claim 16, wherein the membrane filter is a ceramic membrane filter.

18. The method according to claim 16, wherein the membrane filter is a polymer membrane filter.

19. The product of the process according to claim 14.

20. A method for preparing an alcoholic Toddy drink from a toddy juice collected from a stalk of a coconut, a stalk of a palm tree, or coconut water, the method comprising the step of:
deactivating yeast in the toddy juice by only filtering the toddy juice to produce the alcoholic Toddy drink,
wherein no refrigeration, no pasteurization, and no chemical additives are used in the yeast deactivating step.

21. The method according to claim 20, wherein a Porcelain filter is used in the filtering step.

22. The method according to claim 20, wherein a membrane filter is used in the filtering step.

23. The method according to claim 22, wherein the membrane filter is a ceramic membrane filter.

24. The method according to claim 22, wherein the membrane filter is a polymer membrane filter.
